(19) United States
(12) Patent Application Publication
(10) Pub. No.: US 2003/0182382 A1
(43) Pub. Date: Sep. 25, 2003

(54) Apparatus, system and method for accessing a mailbox associated with a wireless network

(76) Inventor: Royce D. Jordan JR., Lawrenceville, GA (US)

Correspondence Address: KIRKPATRICK & LOCKHART LLP, 535 SMITHFIELD STREET, PITTSBURGH, PA, 15222, US

(21) Appl. No.: 10/337,137

(22) Filed: Jan. 6, 2003

Related U.S. Application Data
(63) Continuation of application No. 10/097,332, filed on Mar. 14, 2002.
(60) Provisional application No. 60/343,755, filed on Dec. 27, 2001.

(51) Int. Cl. G06F 15/16

(52) U.S. Cl. 709/206

(57) ABSTRACT

An apparatus for accessing a mailbox associated with a wireless network from an external network. The apparatus includes a server in communication with the wireless network and the external network. The server includes a processor. The processor includes a message receive module and a message send module. The message receive module is for receiving a request to access the mailbox via the external network. The message send module is for sending mailbox information via the external network in response to the request.

### CROSS-REFERENCE TO RELATED APPLICATION

This application claims priority under 35 U.S.C. §119(e) to U.S. Provisional Patent Application No. 60/343,755.

### BACKGROUND

A user of a wireless device has the ability to send and receive a text message via a wireless network, and to edit a profile of the user while the user is located within a coverage area served by the wireless network. However, as a user of the wireless device travels outside a given coverage area, the user loses the ability to communicate via the wireless network. If a text message is sent to the user while the user is located outside the coverage area of the wireless network, the text message will stay in the mailbox of the user and will not be received by the user until the user enters a geographic area served by the wireless network. As a result, the user may be unaware of the text message for an unacceptable period of time. In addition, if the user wishes to edit a user profile while the user is outside the coverage area of the wireless network, the user will be unable to do so until the user enters a geographic area served by the wireless network. Thus, there exists a need for an apparatus, system and method for accessing a mailbox associated with a wireless network, and for editing a profile of a user associated with a wireless network, that overcomes known limitations, shortcomings, and disadvantages.

### SUMMARY

According to one embodiment, the present invention provides an apparatus for accessing a mailbox associated with a wireless network from an external network. The apparatus includes a server in communication with the wireless network and an external network, wherein the server includes a processor. The processor includes a message receive module for receiving a request to access the mailbox via the external network, and a message send module for sending mailbox information via the external network in response to the request.

According to another embodiment, the invention provides a system for accessing a mailbox associated with a wireless network from an external network. The system includes a gateway in communication with the wireless network and the external network, wherein the gateway includes a server. The server includes a processor, and the processor includes a message receive module for receiving a request to access the mailbox via the external network, and a message send module for sending mailbox information via the external network in response to the request.

According to another embodiment, the invention provides a method for accessing a mailbox associated with a wireless network via an external network. The method includes connecting to the Internet from the external network, requesting a web page, selecting a hyperlink displayed on the web page, inputting a user name, and inputting a password.

According to another embodiment, the invention provides an apparatus for editing a profile of a user associated with a wireless network via an external network. The apparatus includes a database machine in communication with the wireless network and the external network, wherein the database machine includes a processor. The processor includes an edit request module for receiving a request to alter the profile of the user via the external network, and an update module for altering the profile of the user.

According to another embodiment, the invention provides a system for editing a profile of a user associated with a wireless network via an external network. The system includes a gateway in communication with the wireless network and the external network, wherein the gateway includes a database machine. The database machine includes a processor, and the processor includes an edit request module for receiving a request to alter the profile of the user via the external network, and an update module for altering the profile of the user.

According to another embodiment, the invention provides a method for editing a profile of a user associated with a wireless device via an external network. The method includes connecting to the Internet via from the external network, requesting a web page, selecting a hyperlink displayed on the web page, inputting a user name, inputting a password, and altering information associated with the profile.

These and various other embodiments of the invention are pointed out with particularity in the claims annexed hereto and forming a part hereof. For a better understanding of the invention, however, reference should be made to the drawings which form a further part hereof, and to the accompanying descriptive matter, in which there are illustrated and described specific examples of an apparatus and method in accordance with the invention.

### BRIEF DESCRIPTION OF THE DRAWINGS

FIG. 1 illustrates a simplified block diagram of a system according to one embodiment of the present invention;

FIG. 2 illustrates one embodiment of the wireless network of FIG. 1;

FIG. 3 illustrates one embodiment of the gateway of FIG. 1;

FIG. 4 illustrates one embodiment of the server of FIG. 3;

FIG. 5 illustrates one embodiment of the database machine of FIG. 3;

FIG. 6 illustrates a process flow according to one embodiment of the present invention; and

FIG. 7 illustrates a process flow according to another embodiment of the present invention.

### DESCRIPTION

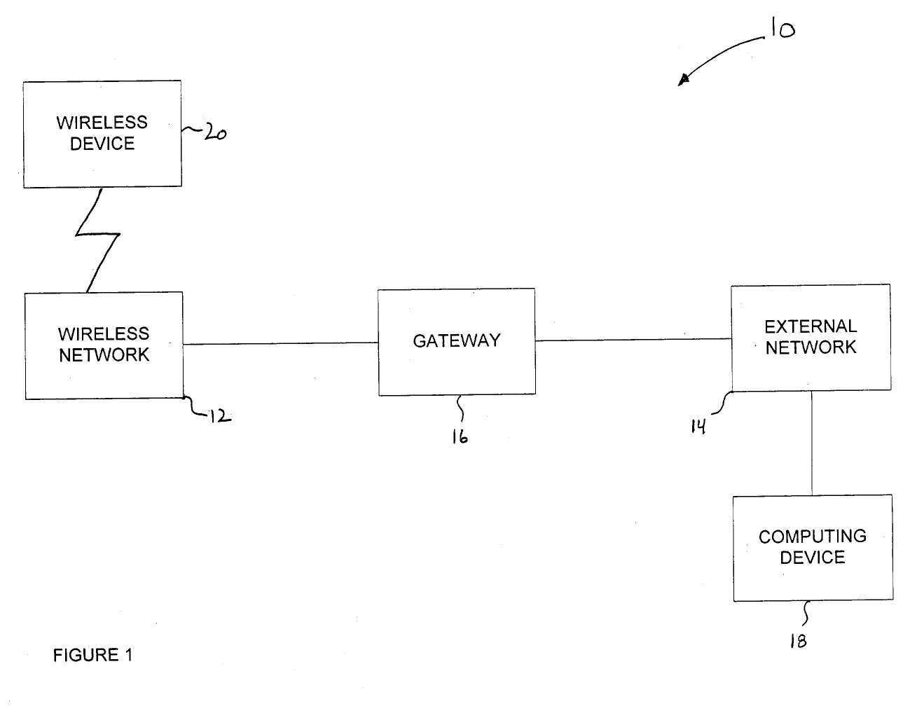

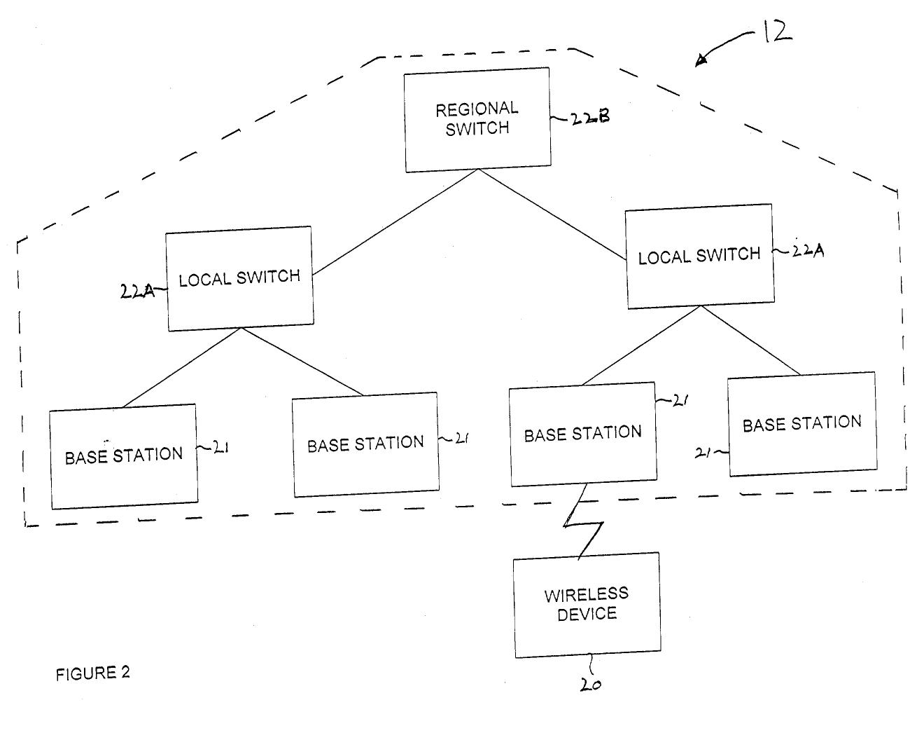

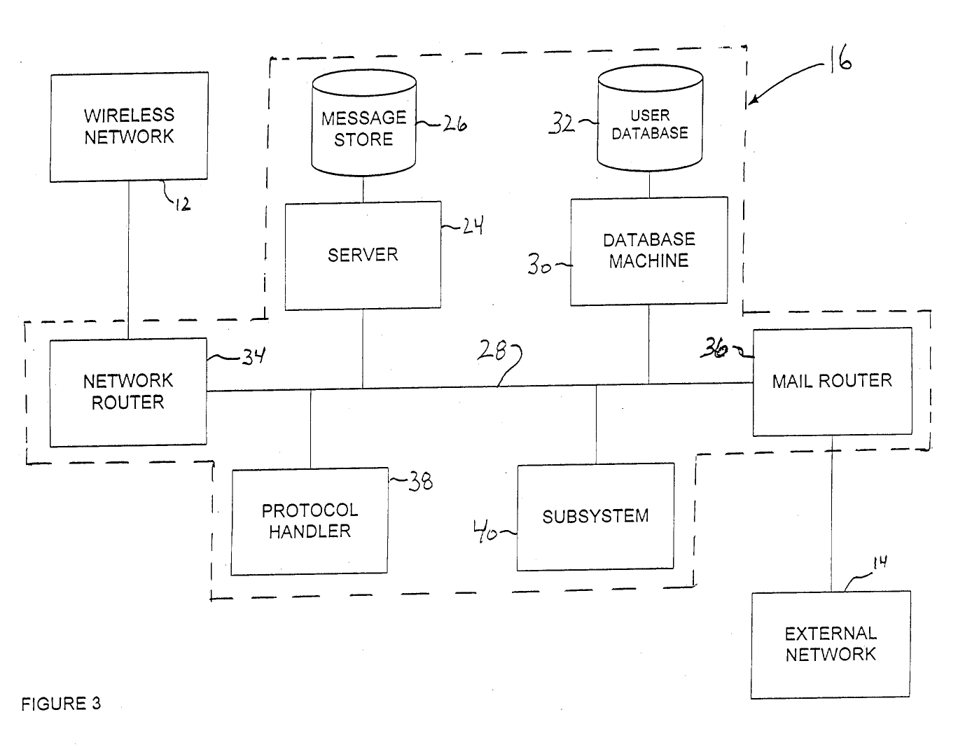

FIG. 1 illustrates a simplified block diagram of a system 10 according to one embodiment of the present invention. The system 10 may include a wireless network 12, an external network 14, and a gateway 16 in communication with the wireless network 12 and the external network 14. The external network 14 may be, for example, the Internet, and may have a computing device 18 such as, for example, a laptop computer, in communication therewith. The communication between the gateway 16 and the wireless network 12 may use, for example, the X.25 protocol, and the communication between the gateway 16 and the external network 14 may use, for example, the TCP/IP protocol. The wireless network 12 and the gateway 16 will be described in more detail hereinbelow with respect to FIGS. 2 and 3, respectively.

FIG. 2 illustrates one embodiment of the wireless network 12 of FIG. 1. The wireless network 12 may be in communication with a wireless device 20 such as, for example, a wireless pager, a personal digital assistant (PDA), a wireless telephone, a wireless personal computer, a wireless modem, or any wireless device configured to communicate with the wireless network 12. The wireless network 12 may include one or more radio base stations 21. Each radio base station 21 services a different radio cell, and each radio cell may have a diameter of approximately ten to twenty miles, depending on environmental and other conditions. The radio base stations 21 define the coverage area of the wireless network 12. In operation, the wireless device 20 communicates with its nearest base station 21, but is also able to communicate with other base stations 21 as its location changes. The wireless device 20 may communicate with the wireless network 12 using an over-the-air protocol such as HP98 or the Blackberry protocol developed by RIM (Research in Motion). The wireless network 12 may also include one or more switches 22 that are organized in a hierarchy of local switches 22A and regional switches 22B connected to one another by fixed communication links. The switches 22 route communication traffic between the radio base stations 21, and one or more of the switches 22 may provide a connection to the gateway 16. According to one embodiment, the wireless network 12 may be a Mobitex® network operated by Cingular Interactive, and the communications between the wireless device 20 and the wireless network 12 are text messages.

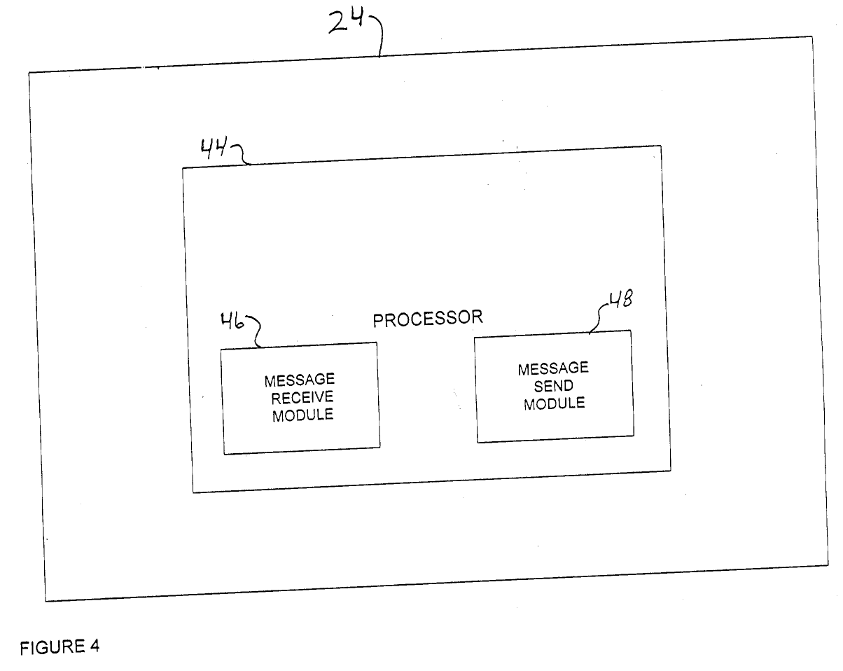

FIG. 3 illustrates one embodiment of the gateway 16 of FIG. 1. The gateway 16 includes a server 24 having a message store 26 associated therewith. The server 24 may be implemented as, for example, a network file system (NFS) server, and will be described in more detail hereinbelow with respect to FIG. 4.

The message store 26 is in communication with the server 24, and may be implemented as a database configured with a directory structure. The message store 26 may include a mailbox for storing information that has been sent to a wireless device 20 associated with the wireless network 12. Information stored in the mailbox may be represented by the data held in one or more of the fields of a record in the database. The message store 26 may also include a plurality of mailboxes, each mailbox being associated with a different user that is associated with the wireless network 12, and the directory structure may be used to identify a particular mailbox. The message store 26 may comprise a portion of the server 24 or may be located external to the server 24. According to one embodiment, the gateway 16 may also include a plurality of message stores 26, and each message store 26 may serve as a backup to the other message stores 26.

The gateway 16 may also include an internal network 28, a database machine 30 having a user database 32 associated therewith, a network router 34, a mail router 36, and a protocol handler 38. The internal network 28 may be connected to the server 24, the database machine 30, the network router 34, the mail router 36, and the protocol handler 38, and may, for example, be implemented as a local area network (LAN).

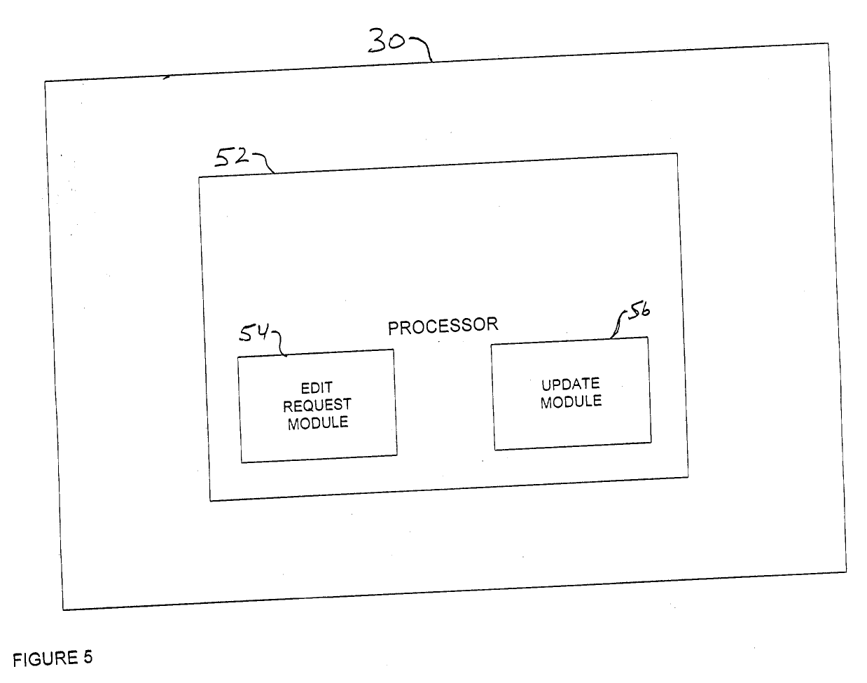

The database machine 30 may be implemented as a c-tree server manufactured by FairCom Corporation, and will be described in more detail hereinbelow with respect to FIG. 5. The user database 32 is in communication with the database machine 30, and may be configured with a directory structure. The user database 32 may include a profile associated with a user of the wireless network 12, and the profile may be edited at any time. Such a profile may include the name of the user, a password associated with the user, a user account number, a unique identifier such as, for example, a unique access number associated with the user, a list of services subscribed to, and a list of addresses that any messages held in the user's mailbox should be sent to. The profile may be represented by data held in one or more fields of a record in the user database 32. The user database 32 may also include a plurality of profiles, each profile being associated with a different user that is associated with the wireless network 12, and the directory structure may be used to identify a particular profile. The user database 32 may comprise a portion of the database machine 30 or may be located external to the database machine 30. According to one embodiment, the gateway 16 may include a plurality of database machines 30 that may serve as a backup to the other database machines 30.

The network router 34 is connected to the wireless network 12 and the internal network 28, and may use the X.25 protocol to communicate with one or more of the wireless network switches 22 via fixed communication links. The network router 34 may include up to two dual-ported connectivity cards. Thus, the network router 34 may include up to four fast-sequenced transport (FST) connections. The network router 34 may receive message packets from and send message packets to the wireless network 12. The network router 34 may also route the message packets received from the wireless network 12 to the protocol handler 38 via the internal network 28. Communications between the network router 34 and the protocol handler 38 may use the user datagram protocol (UDP) that comprises a part of the TCP/IP protocol suite. According to one embodiment, the gateway 16 may include up to 255 network routers 34, and each network router 34 may serve as a backup to the other network routers 34.

The mail router 36 is connected to the external network 14 and the internal network 28, and may use the TCP/IP protocol to communicate with the external network 14 via a fixed communication link. The mail router 36 may receive message packets from and send message packets to the external network 12. The mail router 36 may also route the message packets received from the external network 14 to the protocol handler 38 via the internal network 28. Communications between the mail router 36 and the protocol handler 38 may use the user datagram protocol (UDP). According to one embodiment, the gateway 16 may include a plurality of mail routers 36, and each mail router 36 may serve as a backup to the other mail routers 36.

The protocol handler 38 is connected to the internal network 28, and may process communications received by the gateway 16 from the wireless network 12 or the external network 14. The underlying protocol for decoding messages received from or packaging messages sent to the wireless network 12 and the external network 14 may be simple mail transfer protocol (SMTP). The protocol handler 38 may communicate with the server 24, the database machine 30, the network router 34 and the mail router 36 using X-sockets over internal network 28. Such sockets may be, for example, point-to-point, two-way software communications interfaces that direct the protocol handler 38 to access the internal network 28 by creating a communications end-point or socket and returning a file descriptor with which to access the socket. The protocol handler 38 may also maintain a database cache (not shown), i.e., a small, fast memory holding recently accessed data, to speed up internal network communications and to limit database access requests over the LAN.

The protocol handler 38 may handle protocols associated with the wireless network 12 and the external network 14. The protocol handler 38 may be a UNIX machine, and the protocols handled by the protocol handler 38 may specify that the storage of and access to messages in the message store 26 may be handled by a UNIX-based network file system (NFS) that allows data to be shared across the internal network 28 regardless of the protocol. According to one embodiment, the gateway 16 may include a plurality of protocol handlers 38, and each protocol handler 38 may serve to back up the other protocol handlers 38.

The gateway 16 may also include one or more subsystems 40 that are connected to the internal network 28. The subsystems 40 may communicate with a user via the wireless network 12, and may include, for example, a wireless paging system, a faxmail system, or an interactive voice response system (IVRS).

According to one embodiment, the gateway 16 may be configured as a standard Santa Cruz Operation (SCO) UNIX system. The gateway 16 may use both TCP/IP and UDP for communications, and hypertext markup language (HTML) may be used to support Internet web browsers, including those provided by Netscape and Microsoft. The application programs used by the gateway components may be written in, for example, the C programming language, Java or HTML.

FIG. 4 illustrates one embodiment of the server 24 of FIG. 3. The server 24 may include a processor 44. The server 24 may also include an interface to content addressable memory (CAM) (not shown) for updating information stored in the message store 26. The processor 44 may be a central processing unit (CPU) including, e.g., a microprocessor, an application specific integrated circuit (ASIC), or one or more printed circuit boards. The processor 44 may include a message receive module 46 for receiving a request to access a mailbox via the external network 14, and a message send module 48 for sending mailbox information to the external network 14 in response to the request.

The modules 46, 48 may be implemented as microcode configured into the logic of the processor 44, or may be implemented as programmable microcode stored in an electrically erasable programmable read only memory (EEPROM). According to another embodiment, the modules 46, 48 may be implemented as software code to be executed by the processor 44. The software code may be written in any suitable programming language using any suitable programming technique. For example, the software code may be written in C using procedural programming techniques, or in Java or C++ using object-oriented programming techniques. The software code may be stored as a series of instructions or commands on a computer readable medium, such as a random access memory (RAM) or a read only memory (ROM), a magnetic medium such as a hard-drive or a floppy disk, or an optical medium such as a CD-ROM.

FIG. 5 illustrates one embodiment of the database machine 30 of FIG. 3. The database machine 30 may include a processor 52. The database machine 30 may also contain an interface to content addressable memory (CAM) (not shown) for updating information stored in the user database 32. The processor 52 may be a central processing unit (CPU) including, e.g., a microprocessor, an application specific integrated circuit (ASIC), or one or more printed circuit boards. The processor 52 may include an edit request module 54 for receiving a request to alter the profile of a user via the external network 14, and an update module 56 for altering the profile of the user.

The modules 54, 56 may be implemented as microcode configured into the logic of the processor 52, or may be implemented as programmable microcode stored in an electrically erasable programmable read only memory (EEPROM). According to another embodiment, the modules 54, 56 may be implemented as software code to be executed by the processor 52. The software code may be written in any suitable programming language using any suitable programming technique. For example, the software code may be written in C using procedural programming techniques, or in Java or C++ using object-oriented programming techniques. The software code may be stored as a series of instructions or commands on a computer readable medium, such as a random access memory (RAM) or a read only memory (ROM), a magnetic medium such as a hard-drive or a floppy disk, or an optical medium such as a CD-ROM.

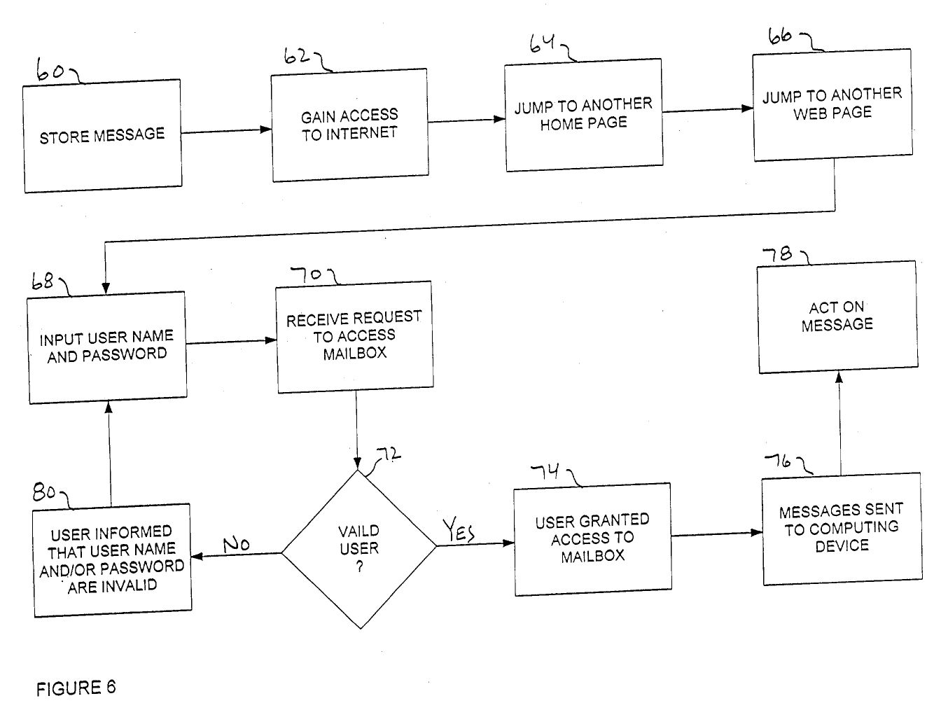

FIG. 6 illustrates a process flow according to one embodiment of the present invention. As described hereinbefore, a message sent to a user of the wireless device 20 may be stored at the message store 26 in a mailbox associated with the user. If the user is located outside the coverage area of the wireless network 12 and unable to access the message via the wireless network 12, one embodiment of the present invention may allow the user to access the message via the computing device 18 connected to the external network 14.

The process begins at block 60, where a message sent to a user of a wireless device 18 is stored at the message store 26 in a mailbox associated with the user. From block 60, the process proceeds to block 62, where the user gains access to the Internet via the computing device 18 connected to the external network 14. When the user gains access to the Internet, the computing device 18 will display its home page, a visual representation of the first information interpreted by a browser of the computing device 18. From block 62, the process proceeds to block 64, where the user jumps to the home page of another web site such as, for example, www.imcingular.com. The user may effectuate the jump by clicking onto a hyperlink or by entering a URL into an address space on a toolbar of the browser. From block 64, the process proceeds to block 66, where the user jumps from the home page of the web site to another web page that comprises a portion of the web site. The user may effectuate this jump by clicking onto a hyperlink or by entering a universal resource locator (URL) into the address space on the toolbar of the browser. This web page may be titled, for example, “mailbox access” and may include a prompt for the user to enter a user name and a password. From block 66, the process proceeds to block 68, where the user requests access to the contents of the user's mailbox by inputting a user name and password. From block 68, the process proceeds to block 70, where the message receive module 46 of the server 24 receives the request to access the mailbox. From block 70, the process proceeds to block 72, where the database machine 30 compares the user name and password that was input at block 68 to the user names and passwords maintained in the user database 32 to determine if the user is a valid user.

If the user name and password input at block 68 matches a user name and password maintained in the user database 32, the user is authenticated as a valid user, and the process proceeds from block 72 to block 74, where the user is granted access to the mailbox. From block 74, the process proceeds to block 76, where the message send module 48 of the server 24 sends each message stored in the user's mailbox to the computing device 18 via the external network 14. From block 76, the process proceeds to block 78, where the user may act on each message by reading, forwarding, or deleting the message.

If the user name and password input at block 68 does not match a user name and password maintained in the user database 32, the user is not authenticated as a valid user, and the process proceeds from block 72 to block 80, where the user is informed that the user name and/or the password entered at block 68 are invalid, and the user is prompted again to enter a user name and password. From block 80, the process proceeds back to block 68, where the process proceeds as described hereinabove. According to one embodiment, the user may only be given a predetermined number of chances to enter a valid user name and password before access to the mailbox is denied.

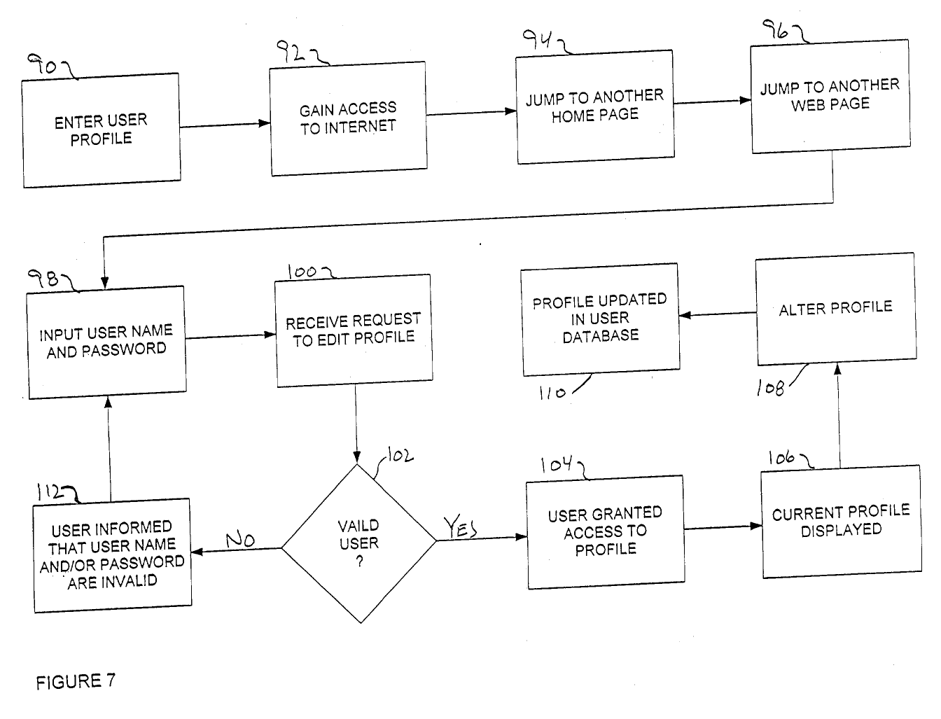

FIG. 7 illustrates a process flow according to another embodiment of the present invention. As described hereinbefore, a profile associated with a user of the wireless network 12 may be edited at any time. If the user is located outside the coverage area of the wireless network 12 and unable to edit the profile via the wireless network 12, one embodiment of the present invention may allow the profile to be edited from the computing device 18 connected to the external network 14.

The process begins at block 90, where a profile of a user associated with a wireless network is entered into the user database 32. From block 90, the process proceeds to block 92, where the user gains access to the Internet via the computing device 18 connected to the external network 14. When the user gains access to the Internet, the computing device 18 will display its home page, a visual representation of the first information interpreted by a browser of the computing device 18. From block 92, the process proceeds to block 94, where the user jumps to the home page of another web site such as, for example, www.imcingular.com. The user may effectuate the jump by clicking onto a hyperlink or by entering a URL into an address space on a toolbar of the browser. From block 94, the process proceeds to block 96, where the user jumps from the home page of the web site to another web page that comprises a portion of the web site. The user may effectuate this jump by clicking onto a hyperlink or by entering a URL into the address space on the toolbar of the browser. This web page may be titled, for example, “edit profile” and may include a prompt for the user to enter a user name and a password. From block 96, the process proceeds to block 98, where the user requests access to the user's profile by inputting a user name and password. From block 98, the process proceeds to block 100 where the edit request module 54 of the database machine 30 receives the request to edit the profile. From block 100, the process proceeds to block 102, where the database machine 30 compares the user name and password that was input at block 98 to the user names and passwords maintained in the user database 32 to determine if the user is a valid user.

If the user name and password input at block 98 matches a user name and password maintained in the user database 32, the user is authenticated as a valid user, and the process proceeds from block 102 to block 104, where the user is granted access to the profile maintained in the user database 32. From block 104, the process proceeds to block 106, where the profile is displayed at computing device 18 connected to the external network 14. From block 106, the process proceeds to block 108, where the user alters the profile displayed on the computing device 18 connected to the external network 14. The user may alter the displayed profile by adding information to the displayed profile, by deleting information from the displayed profile, or a combination of the two. Such alterations may include, for example, a change to the password, a change to the list of services subscribed to, or a change to the a list of addresses that any messages held in the user's mailbox should be sent to. From block 108, the process proceeds to block 110, where the update module alters the profile maintained in the user database 32 to reflect the changes entered at block 108.

If the user name and password input at block 98 does not match a user name and password maintained in the user database 32, the user is not authenticated as a valid user, and the process proceeds from block 102 to block 112, where the user is informed that the user name and/or the password entered at block 98 are not valid, and the user is prompted again to enter a user name and password. From block 112, the process proceeds back to block 98, where the process proceeds as described hereinabove. According to one embodiment, the user may only be given a predetermined number of chances to enter a valid user name and password before access to the profile is denied.

While several embodiments of the invention have been described, it should be apparent, however, that various modifications, alterations and adaptations to those embodiments may occur to persons skilled in the art with the attainment of some or all of the advantages of the present invention. It is therefore intended to cover all such modifications, alterations and adaptations without departing from the scope and spirit of the present invention as defined by the appended claims.

What is claimed is:

1. An apparatus for accessing a mailbox associated with a wireless network from an external network, the apparatus comprising:
a server in communication with the wireless network and the external network, wherein the server includes a processor, the processor including:
a message receive module for receiving a request to access the mailbox via the external network; and
a message send module for sending mailbox information via the external network in response to the request.

2. The apparatus of claim 1, wherein the server includes a database for storing mailbox information.

3. The apparatus of claim 2, wherein the database has a directory structure for identifying the mailbox.

4. The apparatus of claim 2, wherein the mailbox information includes a text message.

5. The apparatus of claim 2, wherein the mailbox information includes a plurality of text messages.

6. The apparatus of claim 1, wherein the external network is the Internet.

7. An apparatus for accessing a mailbox associated with a wireless network from an external network, the apparatus comprising:
a server in communication with the wireless network and the external network, wherein the server includes a processor, the processor including:
means for receiving a request to access the mailbox via the external network; and
means for sending mailbox information via the external network in response to the request.

8. An apparatus for editing a profile of a user associated with a wireless network via an external network, the apparatus comprising:
a database machine in communication with the wireless network and the external network, wherein the database machine includes a processor, the processor including:
an edit request module for receiving a request to edit the profile of the user via the external network; and
an update module for altering the profile of the user.

9. The apparatus of claim 8, wherein the server includes a database for storing the profile of the user.

10. The apparatus of claim 9, wherein the database has a directory structure for identifying the profile.

11. The apparatus of claim 9, wherein the profile includes a username.

12. The apparatus of claim 9, wherein the profile includes a password.

13. The apparatus of claim 9, wherein the profile includes a user account number.

14. The apparatus of claim 9, wherein the profile includes a unique identifier.

15. The apparatus of claim 14, wherein the unique identifier includes an access number associated with the user.

16. The apparatus of claim 15, wherein the profile includes a service subscribed to by the user.

17. The apparatus of claim 16, wherein the profile includes a delivery address for a message held in the mailbox.

18. The apparatus of claim 8, wherein the external network is the Internet.

19. An apparatus for editing a profile of a user associated with a wireless network via an external network, the apparatus comprising:
a database machine in communication with the wireless network and the external network, wherein the database machine includes a processor, the processor including:
means for receiving a request to edit the profile of the user via the external network; and
means for altering the profile of the user.

20. A system for accessing a mailbox associated with a wireless network from an external network, the system comprising:
a gateway in communication with the wireless network and the external network, wherein the gateway includes a server, wherein the server includes:
a processor, the processor including:
a message receive module for receiving a request to access the mailbox via the external network; and
a message send module for sending mailbox information via the external network in response to the request.

21. The system of claim 20, wherein the gateway further includes:
an internal network;
a network router connected to the internal network;
a protocol handler connected to the internal network;
a database machine connected to the internal network; and
a mail router connected to the internal network.

22. The system of claim 21, wherein the internal network is a local area network.

23. The system of claim 21, wherein the network router is connected to the wireless network.

24. The system of claim 21, wherein the database machine includes a database for authenticating a user of the wireless network.

25. The system of claim 21, wherein the mail router is connected to the external network.

26. A system for editing a profile of a user associated with a wireless network via an external network, the system comprising:
a gateway in communication with the wireless network and the external network, wherein the gateway includes a database machine, wherein the database machine includes:
a processor, the processor including:
an edit request module for receiving a request to edit the profile of the user via the external network; and
an update module for altering the profile of the user.

27. The system of claim 26, wherein the gateway further includes:
an internal network;
a network router connected to the internal network;
a protocol handler connected to the internal network;
a mail router connected to the internal network.

28. The system of claim 27, wherein the internal network is a local area network.

29. The system of claim 27, wherein the network router is connected to the wireless network.

30. The system of claim 27, wherein the mail router is connected to the external network.

31. A computer-readable medium having stored thereon a set of instructions which, when executed by a processor, cause the processor to:
serve a web page;
authenticate a user; and
send mailbox information associated with a wireless network mailbox to an external network.

32. A computer-readable medium having stored thereon a set of instructions which, when executed by a processor, cause the processor to:
serve a web page;
authenticate a user; and
alter a profile associated with a wireless network mailbox via an external network.

33. A method for accessing a mailbox associated with a wireless network via an external network, the method comprising:
connecting to the Internet from the external network;
requesting a web page;
selecting a hyperlink displayed on the web page;
inputting a user name; and
inputting a password.

34. The method of claim 33, wherein requesting a web page includes clicking onto a hyperlink.

35. The method of claim 33, wherein requesting a web page includes entering a universal resource locator into an address space on a toolbar of a browser.

36. The method of claim 33, wherein selecting a hyperlink displayed on the web page includes selecting a hyperlink associated with the mailbox.

37. A method for editing a profile of a user associated with a wireless network via an external network, the method comprising:
connecting to the Internet from the external network;
requesting a web page;
selecting a hyperlink displayed on the web page;
inputting a user name;
inputting a password; and
altering a displayed profile.

38. The method of claim 37, wherein requesting a web page includes clicking onto a hyper link.

39. The method of claim 37, wherein requesting a web page includes entering a universal resource locator into an address space on a toolbar of a browser.

40. The method of claim 37, wherein selecting a hyperlink displayed on the web page includes selecting a hyperlink associated with the profile.

41. The method of claim 37, wherein altering a displayed profile includes deleting information from the displayed profile.

42. The method of claim 37, wherein altering a displayed profile includes adding information to the displayed profile.

43. The method of claim 37, wherein altering a displayed profile includes deleting information from the displayed profile and adding information to the displayed profile.
